(19) United States
(12) Patent Application Publication
(10) Pub. No.: US 2009/0061400 A1
(43) Pub. Date: Mar. 5, 2009

(54) Unknown

(76) Inventor: Ross B Rosenfeld, Lynbrook, NY (US)

Correspondence Address: Ross Rosenfeld, 22 Kowall Place, Lynbrook, NY, 11563, US

(21) Appl. No.: 11/899,138

(22) Filed: Sep. 5, 2007

(51) Int. Cl. G09B 17/00

(52) U.S. Cl. 434/178

(57) ABSTRACT

The Ross Tutoring System (RTS) for reading is based on phonetic popularity. Its uniqueness comes from the grouping of sounds in a fashion that is easy for kids to learn by, and by various other methods detailed in my attached description. Along with these groupings of sounds are various support materials, including games, reading materials, and spelling sheets, all of which are described. These games, reading materials, and spelling sheets are unique as well, and provide support for this new, more effective way of teaching reading. Hands-on reading is also an essential part of my approach.

### FIELD OF INVENTION

The Ross Tutoring System is a reading system in the educational field. Its goal is to teach reading and spelling in a clearer, more efficient manner.

### BACKGROUND

Many systems have evolved over the years to teach reading. Since Noah Webster's speller, phonics has always been a strong part of learning to read. This was usually done through a basic familiarity with the various sounds and constant repetition. Such formal training continued through the times of the one-room schoolhouse and the advances made by Horace Mann.

Various phonetic-based systems have developed over the years to help children learn to read, including Hooked on Phonics and the Wilson System. Hooked on Phonics and the Wilson System differ greatly from the system that I've developed. Hooked on Phonics concentrates mostly on games, usually electronic, and has no set order or arrangement of sounds. It is more of a “trial and error” teacher, which gets children to give responses over and over again to improve their reading and spelling. The Wilson System is more didactic than our system, and it takes a completely different route after the initial learning of the alphabet. Wilson uses a “finger-touch” method to get kids to combine letter sounds to make small words, whereas my system uses a Two-and-Three letter method, and only for those kids who don't put sounds together on their own. We also use a Rotating Vowel approach, which will be described in the following pages. We use a much more active, hands-on approach than Wilson. Although Wilson does incorporate reading into its lessons, they do not have games like we do. Furthermore, they do not have the unique approach to teaching syllables that we do. Most importantly, though, they have not arranged the phonetic sounds into the groupings that I have—groupings that make it much easier for the child to learn.

In the 1980's, “sight words” began to emerge. Our system is the polar opposite. We do teach sight words, but we teach them through reading and hands-on experiences. To us, teaching sight words is like teaching the exception before the rule, and we don't do that. Sight words are learned through context, trial and error, and explanation during reading in our system.

Along with sight words, some schools have been promoting the idea of having kids look at illustrations to help them figure-out words. We do not do this. Our system concentrates on text. It is my belief that concentrating on pictures or illustrations builds a dependency on such things, takes away from the richness of text, and decreases the use of imagination and interpretation.

### ROSS TUTORING READING SYSTEM

### Summary and Overview of System

The Ross Tutoring System (RTS) for reading is based on phonetic popularity. Its uniqueness comes from the grouping of sounds in a fashion that is easy for kids to learn by, and by various other methods detailed in the following pages. Along with these groupings of sounds are various support materials, including games, reading materials, and spelling sheets, all of which will be described in the following pages. These games, reading materials, and spelling sheets are unique as well, and provide support for this new, more effective way of teaching reading. Hands-on reading is also an essential part of my approach. Children are able to gauge their own success through our points system, and are generally rewarded with small prizes. The prizes can be books or other learning-related materials, or simply other prizes approved by a parent or guardian. The points system is a helpful but not integral part of the system. The instructor should track each child's progress with notes.

The term “child” will be used throughout this document, though the system can be used for adults as well with some minor adjustments.

### BRIEF DESCRIPTION OF ACCOMPANYING DOCUMENTS

Section entitled Games: describes the various games that we play with the children to facilitate learning
Section entitled Small Words: these are the words we first use with the child after the child is familiar with the alphabet and learning to put together sounds
Section entitled Sounds: these are the Sound Sheets, the most critical aspect of our system; you can see how the sounds are arranged in a way that makes learning to read easier
Section entitled Support Words: these words correlate with the Sound Sheets; the instructor uses these words to practice with and quiz the child
Section entitled Reading Words: these are more advanced words that help the child practice both the sounds he/she has learned and breaking words up by syllable
Section entitled Big Words: these are even more challenging words that shift the concentration to more syllable practice (at this point the child's phonetic awareness should be strong)
Section entitled Spelling Sheets: these are spelling sheets that I've created to help a child practice spelling; they correlate with the Sound Sheets—as the child goes through the various sounds, he/she practices writing those sounds by identifying pictures on the spelling sheets and trying to spell the words; if the child isn't sure what the picture is, it is OK for an instructor to tell the child what it is so that the child can attempt the word
Section entitled Additional Support Materials: these materials offer additional aide; they include sheets that help the child understand the concept of past tense as well as sheets to help the child understand the difficult ION sound; there are also some word game sheets

### Step One: Teaching the Alphabet

The first step in teaching reading in our system is ensuring that the child can identify letter sounds and letters based on sounds. For example, the child must not only know what sound T makes, but must also be able to identify T when he/she hears the T sound.

The learning of these letter sounds is accomplished both in traditional ways, such as the alphabet song or by playing established letter-sound games, and in some novel ways as well. The novel ways include playing the following games which I have devised and which will be described in detail in the section entitled Games: The Jump Game, Toss the Ball, Toss the Candy, the Letter Obstacle Course, the Memory Game, and Letter Basketball.

Letter sounds are also emphasized through reading. At this stage, the person working with the child will ask the child to identify letters, letter sounds by looking at the letter, and what letter is being read when the instructor makes that letter's sound while reading together, generally done at the end of a tutoring session, although not necessarily.

### Step Two: Introducing the Vowels

Once the child is familiar with the alphabet, he/she is told what I refer to as “The Law.” The Law is that no word can be made without a vowel. We introduce the vowels with the following rhyme: A, E, I/O, U, Y. During this step, Y is included as a vowel, though it will later be secluded for purposes of understanding.

The Memory Game is played with the child. The child is reminded of the short sounds that each vowel makes, then told the long sounds. We ask questions such as, “Which letter makes the sound [short E sound]?” and “Which letter makes the sound [long I sound]?” Children can be rewarded for correct answers with points and praise. The vowel sounds can be rehearsed through some of the games mentioned earlier and described in greater detail in the Games section.

We show the child how vowels are used through our Vowel Rotation method. In this method, we choose two consonants, e.g. P and T. We separate the consonants, leaving room for the vowel in between. We then show the child how changing the vowel changes the word. In the case of P and T, for instance, we would continually change the vowel, making the words PAT, PET, PIT, POT, and PUT.

### Step Three: Putting Together Words

Step Three will vary amongst children because some of them can put together words on their own simply by reciting the letter sounds, while others will need help adding the vowel sounds and combining sounds. We help those children who have trouble reading small words through two methods: 1. stretching out the vowel sounds with them so that they can hear it clearer; and 2. The Two-and-Three Letter Approach. In the latter method, the child is asked to say the sound of the first letter, then the sound of the second letter, then the sound both letters make together. After that they are to add the remaining letter or letters to make a word. For example, if the child was reading the word HAT, he/she would first say the H sound, then the A sound, then HA, then HAT.

Going over word endings is also permissible when using our system.

To aide the child in learning to put together words, we use sheets with three and four letter words (and the occasional five-letter word). These sheets are attached, entitled Small Words. These sheets also introduce some of the sounds we will be going over later, such as ST, simply to introduce the concept of combined sounds to the child. We also employ the Acting Game in order to motivate them to read small words.

At this point we will also start training the child to spell words by sounding them out and listening for the vowel sound. Classical spellers, innovative spelling systems from other sources, and our very own spelling sheets can assist the tutor during this time. The instructor may also decide to have the child spell words for points, if the tutor is using a points system. If the instructor is using a puppet (which we do occasionally employ), the instructor may want to have the child compete in spelling or reading against the puppet. Of course, any of the games described in the Games section can be used.

Each session usually ends with a period of reading. The child is to participate in the reading at this point by reading some small words and following along with you as you read. In this fashion, the child not only feels the satisfaction of having read and participated, but also may pick-up the occasional word by seeing you read it, since the instructor is supposed to use his/her finger to help the child follow along. This will also help the child recognize exceptions throughout the English language, or at least introduce the idea that there are exceptions.

### Step Four: Beginning the Sound Sheets

Once the instructor is satisfied that the child has achieved proficiency in reading and writing small words, he/she will have the child move on to our sound sheets. These sound sheets are broken up into phonetic sounds based on phonetic popularity and the ease at which I have found the children learn. In other words, I have broken the phonetic sounds up into a way that I feel is most useful to the child in that it will introduce common and simpler sounds early and less-common and more complex sounds later. Also: combinations that make the same sound, such as EE and EA or AI and AY are grouped together. In addition, sounds that are easier to learn together are grouped together, even though the sounds may be different and their popularity of use may be different (e.g. IGHT and ING are grouped together). The current layout of the sounds along with the sample words used to introduce them are attached in the section entitled Sounds.

To support the learning of these sounds, there are support words. The layout of these words can be found under the Support Words section. These words directly correlate to the sound sheets. As the instructor introduces a new sound, he/she can have the child practice that new sound and review sounds they've done in the past by using these support sheets.

The time that the instructor spends working on each sound will vary from child to child, but I recommend the following as a skeleton in order to give a general idea as to how long it should take:

E making vowels long: 2 sessions (each session being an hour)
EE and EA: 1 session
OO and OR: 1 session
OU and OW: 1 session
SH and CH: 1 session
TH and GH and PH (the main concentration is to be on TH): 1 session
At this point the instructor should do a session of pure review.
TR, etc.: 1 session
DR and review of TR, etc.: 1 session
ST and SL, etc.: 1 session
IGHT and ING: 2 sessions
Y at the End of Words: 1 session
AI and AY: 1 session
AL: 1 session
AU and AW: 1 session
At this point the instructor should do a session of pure review.
OA: 1 session
OI and OY: 1 session
ER and ED: 1 session
ED alone (along with the idea of past tense): 2 more sessions
LE and FUL: 1 session
ION: 2 sessions
Soft C: 1 session
AR: 1 session
IN and OL: 1 session
OUS and TIVE: 1 session
Other sounds are included at the end of our sounds sheets. These sounds can be worked on individually if need be or simply through examples seen by hands-on reading.
At this point the instructor should do a session of pure review.

These sounds will all be reinforced through the support word sheets, spelling sheet (see attached Spelling Sheets), and games. They will also be aided by hands-on reading, usually at the end of every session, although the instructor is of course able to vary this regimen if he/she sees that it benefits the child or children to do so.

A typical session would go like this:

1. 5 minutes reviewing past sounds through the Sound Sheets and Support Words.

2. 10-15 minutes spelling in order to reinforce sounds.

3. 15 minutes introducing a new sound and practicing with it through the Sound Sheets and Support Words.

4. 20 minutes playing games, such as the Jump Game or the Acting Game.

5. The rest of the time spent reading together, with the child taking a more and more active role as he/she learns more and more sounds.

As the instructor takes the child through the various sounds and support words, the instructor should also introduce the concept of syllables, having the child practice breaking words up by syllable. The instructor should explain our Pronounceable Vowel concept to the child, getting the child to count out how many “pronounceable vowel sounds” there are in a word to help determine how many syllables the word has. In words that have combination vowel sounds, such as the word RAINFALL, the child will be taught to count those combinations as one “pronounceable vowel sound.” The child would count AI and A in that word: RAINFALL. In the word INFORMATION, the child would count out the syllables in the following manner: INFORMATION. This way the child knows how many syllables to look for.

It is important that the instructor introduce the concept of syllables early on, and that the instructor use the occasional multi-syllabic word to reinforce the idea with the child. Once the child has finished the Sound Sheets, practicing breaking-up words by syllable will become an even greater concentration.

### Step Five: Spelling and Writing Larger Words

At this point the child is ready to go on to our Reading Words sheets. These words are generally larger than the Support Words, and usually need to be broken-up by syllable. The child must also keep a firm grip on all of the sounds he/she has learned. The Reading Words words are broken up by size and difficulty, and have point values attached.

Games such as the Acting Game, Letter Races, or the Jump Game (or Advanced Jump Game) can be used, as well as spelling sheets and reading materials. The child should be moving on to more independent reading, and the instructor can provide basic reading materials, such as those deemed Level 1 books (early readers). The instructor can start these books with the child, and watch the child as he/she deciphers them. The instructor must make certain that the child is gaining a contextual understanding, and that the child begins making sense of words that have exceptions. As the child makes progress in breaking-up and contextualizing, and as his/her memory of the sounds becomes ever stronger, the instructor can decide to move the child up to higher level books.

After the Reading Words sheets, the instructor can move on to our Big Words sheets. The main idea with these sheets is to get the child used to breaking-up words by syllable.

### Step Six: Moving On to Higher Levels of Reading and Concentrating on Reading Comprehension

The instructor will, of course, ask the child about what they are reading together and what the child may have read without the instructor throughout the process, but at this point—once the child is strong in word defragmentation—greater amount of energy to improving the child's reading comprehension skills. This can be done by using traditional reading comprehension materials (also good for helping the child practice writing sentences) and through direct questions when reading. The instructor may also ask the child to respond to literature. The substance of these responses will vary, depending on the level each child has achieved. For more advanced children (perhaps those moving on to chapter books), the instructor may want have the child keep a journal.

### CONCLUSION

This new, advanced tutoring method is unique in its approach to teaching reading. It's

unique features include: The various games described, the Two-and-Three Letter Method, the Sound Sheets and the grouping of the phonetic sounds based on phonetic popularity and the ease at which children learn, the Pronounceable Vowel concept, the allocation of time and the method in which phonics is combined with activities and reading, the unique spelling sheets that follow the progression of the child and reinforce the sounds he/she has learned while introducing some exceptions, and the clearly defined, gradual but steady progression that is made through the English language to achieve reading.

1. I am claiming a system for teaching reading and spelling through an innovative, phonetic-based approach. The system has several new features that differentiate it from other reading systems. These include a series of games described under the accompanying document reading “Games;” a method I call the Two-and-Three Letter Method, which helps children who have trouble deciphering small words; Sound Sheets with groupings of the phonetic sounds based on phonetic popularity and the ease at which children learn (supported by accompanying word sheets); my Pronounceable Vowel concept, which teaches children to count syllables based on pronounceable vowel sounds; an organization and allocation of time in which phonics is combined with activities and reading, achieving a higher level of efficiency than has been achieved in the past when children have been taught to read; unique spelling sheets that follow the progression of the child and reinforce the sounds he/she has learned while introducing some exceptions, and which make spelling more fun by asking the child to identify a picture; and a clearly defined, gradual but steady method of progression through all of these components that makes it easier to achieve a proficiency in reading.
